(19) United States
(12) Patent Application Publication
(10) Pub. No.: US 2019/0218808 A1
(43) Pub. Date: Jul. 18, 2019

(54) Systems and Methods for Swimming Pool Filtration

(71) Applicant: David Alan Jackson, Spring, TX (US)

(72) Inventor: David Alan Jackson, Spring, TX (US)

(21) Appl. No.: 16/215,649

(22) Filed: Dec. 11, 2018

Related U.S. Application Data
(60) Provisional application No. 62/597,401, filed on Dec. 11, 2017.

(51) Int. Cl. E04H 4/12; B01D 29/13; B01D 29/96; B01D 35/02

(52) U.S. Cl. CPC E04H 4/1272; B01D 35/02; B01D 29/96; B01D 29/13

(57) ABSTRACT

Apparatus and methods for a pool filtration system includes a basket with a netting that is customizably designed and versatile in its functionality. The basket can be made from modern plastic or plastic-like materials. The weather-resistant, durable materials benefit the netting design for capturing and holding debris in a pool filtration system.

### CROSS-REFERENCE TO RELATED APPLICATION

This application claims the benefit of U.S. Provisional Application No. 62/597,401 filed Dec. 11, 2017.

### FIELD OF THE DISCLOSURE

The present invention is generally related to the field of swimming pool filtration.

### BACKGROUND

From time to time, swimming pools receive unwanted deposits such as leaves, twigs, and other debris. If left ignored, this debris detracts from the enjoyment of the pool, dirty the pool, and can have the potential to damage the filtration system, which circulates water into and throughout the pool. Swimming pools must include devices to filter the water in order to maintain a sanitary experience for swimmers. Generally, this is accomplished by the use of water pumps to bring the water to the filtration system and then reintroduce the filtered water back into the pool. However, any debris small enough to fit into the filtration channel could cause problems if it were to reach the water pumping mechanisms. Traditional solutions to this problem have been to include a filter basket to catch debris in the channel before they can cause any problems.

Existing swimming pool filter baskets are generally manufactured as rigid plastic cylinders, with an open top and holes in the sides and bottom arranged in a grid pattern. The holes are designed to allow water to pass through when there is debris in the basket. However, some debris (small leaves, small twigs, seeds, husks, etc.) are small enough to pass through these holes. Any debris that passes through the filter may cause undue wear and tear on the pool filtration system and other mechanical parts of the pump system, including breakage or other temporary or permanent damage. Another difficulty with existing swimming pool filter baskets is the rigid plastic design. The rigidity means that the basket is susceptible to breaking by accidental use, or even by long-term use of the basket. The harsh effects of chlorine or saltwater, prolonged exposure to outdoor elements including sunlight, ultraviolet rays, and temperature extremes, along with the pressure and weight of repeated baskets full of debris make the rigid plastic basket more brittle and prone to more breaks in the basket.

### BRIEF SUMMARY OF THE DISCLOSURE

Some or all of the above needs and/or problems may be addressed by certain embodiments of the disclosure. Certain embodiments can include apparatus and methods for a swimming pool filter basket. According to one embodiment of the disclosure, there is disclosed a basket. The basket can include a netting that is primarily composed of a plastic or other similar material. The netting can be coupled to a rim, which can be primarily plastic or similar material, and the combined basket can fit into the basket-holding cavity of a swimming pool.

According to another embodiment of the disclosure, there is disclosed a method. The method can include configuring the rim and netting to fit into the basket-holding cavity of a swimming pool. The method can also include coupling the rim and netting together.

Other embodiments, apparatus, methods, aspects, and features of the disclosure will become apparent to those skilled in the art from the following detailed description.

### BRIEF DESCRIPTION OF THE DRAWINGS

The detailed description is set forth with reference to the accompanying drawings, which are not necessarily drawn to scale. The use of the same reference numbers in different figures indicate similar or identical terms.

FIG. 1A illustrates an example swimming pool filter basket, according to an embodiment of the disclosure.

FIG. 1B illustrates an example swimming pool filter basket, according to an embodiment of the disclosure.

FIG. 1C illustrates an example swimming pool filter basket, according to an embodiment of the disclosure.

FIG. 1D illustrates an example swimming pool filter basket, according to an embodiment of the disclosure.

FIG. 1E illustrates an example swimming pool filter basket, according to an embodiment of the disclosure.

FIG. 1F illustrates an example basket rim, according to an embodiment of the disclosure.

FIG. 1G illustrates an example basket rim, according to an embodiment of the disclosure.

FIG. 2 is a functional block diagram illustrating an example method of creating a swimming pool filter basket, according to an embodiment of the disclosure.

### DETAILED DESCRIPTION

Illustrative embodiments of the disclosure will now be described more fully hereinafter with reference to the accompanying drawings, in which some, but not all, embodiments of the disclosure are shown. The disclosure can be embodied in many different forms and should not be construed as limited to the embodiments set forth herein; rather, these embodiments are provided so this disclosure will satisfy applicable legal requirements.

Certain embodiments disclosed herein relate to a swimming pool filter basket. Accordingly, an apparatus can be provided to be used as the filter basket for a swimming pool. For example, the basket-holding cavity of a swimming pool can be capable of fitting a universal size basket into the cavity. The apparatus can also be constructed to fit any non-universal sized swimming pool basket cavities. The apparatus can be constructed or configured to fit into any size filtration cavity for in-ground and above-ground swimming pools, residential, commercial, and industrial pools and recreational bodies of water that require filtration systems. The filter basket, as well as its component net, rim, and handle parts, can be round, rounded, oval, or specifically configured to fit into the particular cavity. The rim can be of a completely, or partially, solid construction, and can be of varying thickness. The basket can include surfaces to receive markings or writing that can include advertising and/or description of the design of that particular basket. The netting can be longer or shorter in depth, depending on factors such as the dimensions of the filtration cavity and the amount of debris to be handled by the basket. The basket net can be woven, knitted, sewn, 3-D printed, or otherwise constructed to achieve the desired size, design, and purpose. For example, the holes of the netting can be of varying size and shape depending on the type of debris to be filtered. The netting can be permanently or removably attached to the rim, and attachment can include mechanical attachment such as protrusions, clamps, ties, and pins, adhesive attachment or welding, individually or in combination. The components of the basket can be replaced individually, if necessary.

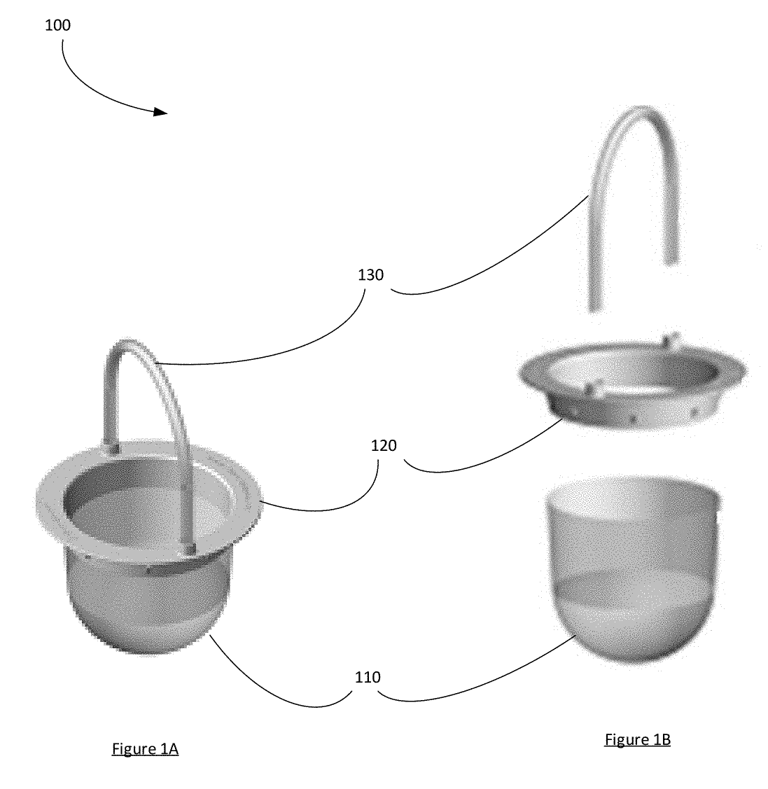

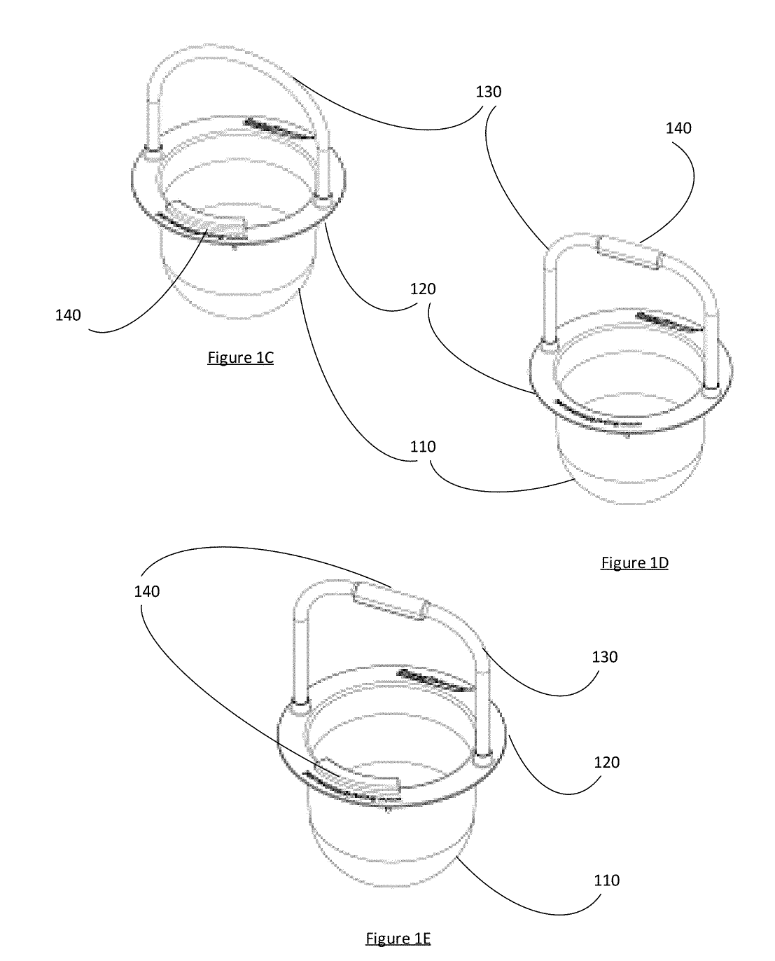

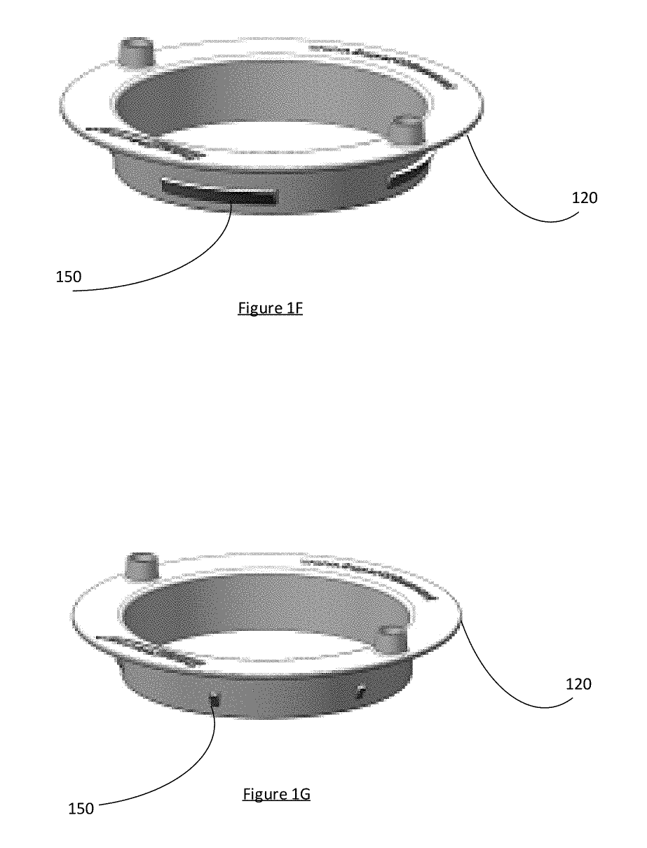

FIGS. 1A and 1B depict an example swimming pool filter basket 100. According to an embodiment of the disclosure, the basket 100 can include netting 110. Netting 110 can be composed of a pliable high-density polyethylene (HDPE), low-density polyethylene (LDPE), or other plastic material suitable for aquatic filtration use. These plastic materials, like HDPE and LDPE, are more durable than traditional materials previously used for filter baskets. They have the strength required to withstand long-term exposure to the elements, heat and cold and sunlight, long-term use in chlorine or saltwater pools, and long-term pressure exerted by the weight of the debris repeatedly caught in the netting 110, as well as the constant flow of water through the basket 100. The plastic used in the components, including netting 110, rim 120, and handle 130, can be a blend of plastic with additives. In some embodiments, the plastic can be mixed with glass, fiberglass, carbon fiber, and metal, to name just a few, in order to add to or strengthen the characteristics of the plastic. The basket 100 also includes rim 120. Rim 120 fits into the basket-holding cavity of the swimming pool. Rim 120 can be composed of HDPE or other plastic material. Rim 120 can also be composed, in whole or in part, of aluminum, stainless steel, or other rust-resistant metal. Rim 120 can be composed of both plastic and metal parts; for example, posts and screws can be metal while washers and bands can be plastic, or vice versa. Netting 110 and rim 120 can be coupled together to ensure the strengths of each component are not weakened at the coupling. This coupling can be permanent, such that neither netting 110 nor rim 120 can be removed from the coupling without causing damage to the basket 100. In some embodiments, a more permanent coupling can be achieved through sonic or heat welding the netting 110 and rim 120 together. But the coupling can also be of a replaceable nature, such as holding the netting 110 tight against rim 120 through use of an elastic or non-elastic band, together with other mounting components, to secure the netting 110 to the outside circumference of the rim 120. In other embodiments, rim 120 can include at one or more posts extending outward from its outer circumference, and netting 110 can include gaps which fit over the rim posts and allow netting 110 to hang from rim 120. In one embodiment, rim 120 can include 8 posts evenly spaced circumferentially around the outside surface of rim 120. In another embodiment, rim 120 can include a clasping ring that snaps to or otherwise couples to the outside circumference of rim 120 and secures netting 110 between the outside circumference and the clasping ring. These various mounting components, posts, clasps, snaps, etc. can be composed of plastic or rust-resistant metal, as described above; and rim 120 can include a combination of rust-resistant metal and plastic posts, screws, etc. In some embodiments, one or more of the above-described couplings can be implemented together. For example, in one embodiment netting 110 can include gaps in the net to be hung on posts extending from rim 120. In that same embodiment, an elastic band can then be tightly fitted around the outside circumference of rim 120, securing netting 110 to rim 120 both by the posts and the elastic band. In yet another embodiment, netting 110 can be coupled to the device by fitting the net material between two rims of varying designs, and then applying a sonic weld, a suitable adhesive material, nuts, bolts, screws, or other suitable fashion such that netting 110 and rim 120 become one unit.

Still with reference to FIGS. 1A and 1B, the filter basket 100 can also include handle 130. Handle 130 can be composed of HDPE, LDPE, or other suitable plastic or similar material. Handle 130 can also be composed, in whole or in part, of aluminum, stainless steel, or other rust-resistant metal. Without limiting the composition of handle 130, handle 130 can include a spine of rust-resistant metal. Whichever construction is used, handle 130 can withstand the tensile forces acting on it, for example, by manipulation. Handle 130 can be coupled to rim 120 such that handle 130 is extended at all times, or handle 130 can be operable to contract or fold down alongside rim 120. In one embodiment, hinges can be used to contract or fold down handle 130, and the hinges can be composed of plastic or similar material, or rust-resistant metal, or both. When folded down, for example, handle 130 can allow for use of a lid or other covering, either for basket 100 or for the cavity, or for both.

With continued reference to FIGS. 1A and 1B, netting 110 can be created from a single swatch of net material. In this way, netting 110 would not require any seams from combining multiple swatches of net material. This embodiment therefore removes the inherent weakness of the seams. In one embodiment, netting 110 can be formed from a pattern of net material which creates one or more pleats in netting 110. The pleats can allow for expansion of netting 110 and permit additional debris from being captured in the basket 100. In another embodiment, netting 10 can be formed from a pattern of net material which does not create any pleats in netting 110. This can be preferred over other embodiments for aesthetic or other purposes. Netting 110 can also contain sewn, heat-welded, sonic-welded, or other suitably connected areas such that the strength of the net material is maintained for the basket's intended use and purpose.

Netting 110 can include holes of varying sizes. In some embodiments, netting 110 can include holes of virtually the same size as traditional skimmer baskets. In other embodiments, netting 110 can include holes much smaller than traditional skimmer baskets. In one embodiment, netting 110 can be composed of holes with diameters in the range of approximately 0.5 millimeters to 2.5 millimeters. The holes can be essentially homogeneous such that all holes can be, for example, very near to 1.0 millimeter in diameter. In another example, the holes can be heterogeneously sized in order to maximize the flow of water through the holes. In another embodiment, the holes can have diameters of approximately 3 millimeters. In some embodiments, netting 110 can include larger holes in order to filter larger debris such as leaves, twigs, and insects. In other embodiments, netting 110 can include smaller holes in order to maximize filtration of smaller particulate matter such as seeds, tree pollen, sand, and other debris from organic or inorganic sources.

Referring now to FIGS. 1C through 1E, shown is another embodiment of swimming pool filter basket 100. Included in the configuration, along with netting 110, rim 120, and handle 130, is light source 140. Light source 140 can be incorporated into basket 100 via handle 130, via rim 120, or via both the handle 130 and rim 120. Light source 140 can be used at any time, and may be most visible at times of lower natural light. Light source 140 can be attached to any part of the filter basket 100. In some embodiments, light source 140 can be attached to the interior body of basket 100 or a basket covering, such as a lid. Light source 140 can be powered by a variety of methods including, but not limited to, battery cell, solar power, hydroelectric power, and traditionally or non-traditionally generated electric power, individually or in combination. In some embodiments, light source 140 can include light-emitting diode (LED) bulbs, fluorescent bulbs, incandescent bulbs, reflecting surfaces, and materials that glow in the dark, individually or in combination.

Referring now to FIGS. 1F and 1G, shown are embodiments of rim 120. To secure netting 110, rim 120 can include notches 150. Notches 150 can be of varying size, design, and placement, and can serve to wedge or hook netting 110 securely with rim 120. In some embodiments, notches 150 can be the sole coupling mechanism between rim 120 and netting 110. In other embodiments, notches 150 can fit against another rigid surface with netting 110 in between, thereby holding netting 110 in place. In some embodiments, notches 150 can be of a size not greater than the area of the holes in netting 110, and can serve as “hooks” from which netting 110 hangs from and is attached to rim 120.

Other embodiments of filter basket 100 can include one or more secondary filtration devices. Secondary filtration devices can manually or automatically trap debris in the filtration cavity of the swimming pool, for example, when a filter basket 100 has been removed. Secondary filtration devices can include a dip net to scoop or otherwise clean debris from the filter cavity. In some embodiments, secondary filtration can include a shaped net situated below filter basket 100. In some embodiments this secondary net, for example circular in shape, can be removably attached to filter basket 100, such that removal of either basket 100 or the secondary net from the cavity does not necessarily include removal of the other from the cavity. The secondary net can be constructed of plastic or similar material, metal, fabric, or resins of various types, among other constructions suitable in a swimming pool environment.

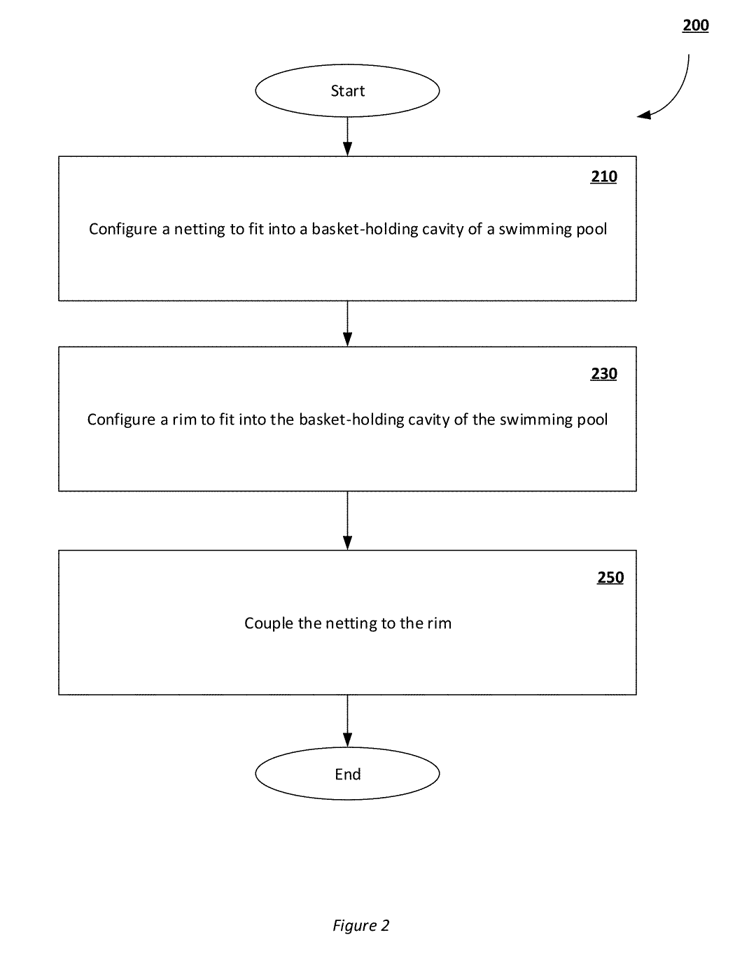

Referring now to FIG. 2, shown is a flow diagram of an example method 200 for configuring a swimming pool water filter basket, according to an illustrative embodiment of the disclosure. The method can be utilized with various apparatus, such as the swimming pool filter basket 100 illustrated in FIG. 1.

The method 200 can begin at block 210. At block 210, a netting can be configured to fit into the basket-holding cavity of a swimming pool. The cavity can be of a universal size, or it can be of a different size that fits the netting. The netting can be composed of a plastic material such as HDPE, LDPE, or other suitable plastic, or resin material. The netting can be configured such that the netting has pleats when it is coupled to a rim; or the netting can be configured such that there are no pleats or folds in the netting after it is coupled to the rim. The netting can also be configured to have holes much smaller than the traditional diameter size of filter basket holes. For example, the netting holes of this disclosure can have diameters in the range of approximately 0.5 mm to 2.5 mm, with a homogeneous or heterogeneous distribution of the hole sizes. Additionally, the netting can be configured without seams, such that the strength of the netting is not compromised by the seams.

Next, at block 230, a rim can be configured to fit into the basket-holding cavity of a swimming pool. The cavity can be of a universal size, or it can be of a different size that fits the rim. The rim can be composed of a plastic material such as HDPE, LDPE, or other suitable plastic, or resin material. The rim can also be composed of aluminum, stainless steel, or other rust-resistant metal. The rim can be coupled to a handle; and the handle can be operable to fold down into being part of the rim.

Next, at block 250, the netting and the rim can be coupled together. The coupling can be permanent or it can be removable, for example, in the interest of replacing one or another part. The netting and rim can be coupled together through sonic welding or heat welding, or with the aid of an adhesive. Alternatively or in concert, the coupling can be achieved through the use of prongs extending from the outside circumference of the rim, such that the netting can contain gaps that fit around these prongs, and the netting hangs from the rim. The prongs can be shaped to prevent the netting from sliding back off the prongs. Alternatively, an elastic band can be stretched tight around the outside circumference of the rim such that the band squeezes the netting between the rim and the band. Yet another alternative in the coupling is to use a clasping ring that locks into place around the outside circumference of the rim and secures the netting between the rim and the clasping ring.

The method 200 can optionally end following block 250.

The operations described and shown in method 200 of FIG. 2 can be carried out or performed in any suitable order as desired in various embodiments of the disclosure, and the method 200 can repeat any number of times. Additionally, in certain embodiments, at least a portion of the operations can be carried out in parallel. Furthermore, in certain embodiments, fewer than or more than the operations described in FIG. 2 can be performed.

Now that these embodiments have been described,

1. A swimming pool filter basket comprising:
a netting comprised primarily of a plastic material; and
a rim coupled to the netting, the rim to fit into a basket-holding cavity of a swimming pool, the rim comprised primarily of the plastic material.

2. The device of claim 1, further comprising a handle coupled to the rim.

3. The device of claim 2, wherein the handle is operable to pivot into a position in general alignment with the rim.

4. The device of claim 1, wherein the handle is comprised primarily of the plastic material.

5. The device of claim 1, wherein the rim and the netting fit into a universally designed space for a filter basket.

6. The device of claim 1, wherein the netting is pleated.

7. The device of claim 1, wherein the netting is seamless.

8. The device of claim 1, wherein the netting comprises holes with a homogeneous distribution of hole diameters.

9. The device of claim 1, wherein the netting comprises holes with a heterogeneous distribution of hole diameters.

10. The device of claim 1, wherein the netting is coupled to the rim by at least one of welding, adhesion/cohesion, hanging, or clasping.

11. A method of filtering a swimming pool water filter basket, the method comprising:
configuring a netting to fit into a basket-holding cavity of a swimming pool;
configuring a rim to fit into the basket-holding cavity of the swimming pool; and
coupling the netting to the rim.

12. The method of claim 11, further comprising coupling a handle to the rim.

13. The method of claim 12, wherein the handle is operable to be incorporated into the rim.

14. The method of claim 11, wherein the netting is comprised primarily of a plastic material.

15. The method of claim 11, wherein the rim is comprised primarily of a plastic material.

16. The method of claim 11, wherein the sizing further comprises dimensioning the netting and the rim to fit into a universal-size space for a filter basket.

17. The method of claim 11, further comprising pleating the netting.

18. The method of claim 11, wherein the netting is seamless.

19. The method of claim 11, wherein configuring the netting comprises configuring holes in the netting with a heterogeneous distribution of hole diameters.

20. The method of claim 11, wherein coupling comprises at least one of welding, adhering/cohering, hanging, or clasping.
